(19) United States
(12) Patent Application Publication
(10) Pub. No.: US 2024/0319738 A1
(43) Pub. Date: Sep. 26, 2024

(54) System and Method for Displaying Animated Images from Wheeled Mobile Robots

(71) Applicants: Andrés Felipe Chavez Cortes, El Cerrito, CA (US); Jose Alejandro Logreira Avila, Envigado (CO); Andres Felipe Rengifo Sanchez, Medellín (CO)

(72) Inventors: Andrés Felipe Chavez Cortes, El Cerrito, CA (US); Jose Alejandro Logreira Avila, Envigado (CO); Andres Felipe Rengifo Sanchez, Medellín (CO)

(21) Appl. No.: 18/611,262

(22) Filed: Mar. 20, 2024

Related U.S. Application Data
(60) Provisional application No. 63/491,244, filed on Mar. 20, 2023.

(51) Int. Cl. G05D 1/60; G05D 105/70; G05D 111/30; G06F 8/51

(52) U.S. Cl. CPC G05D 1/60; G06F 8/51; G05D 2105/70; G05D 2111/32

(57) ABSTRACT

A system and method for animating and displaying images via a mobile robot. The mobile robot includes a screen and a processor wherein the processor executes computer readable commands, thereby displaying animations onto the screen. The method includes the steps of creating animations as GIF files, converting images into code, optimizing frame sequence, translating optimized frames into a C programming data structure, and displaying the optimized frames onto the screen of the mobile robot.

### FIELD OF THE INVENTION

The present invention relates generally to a system and method of displaying animated images. More specifically, the present invention is a method of displaying animated images and GIFs onto a LED screen of a mobile robot.

### BACKGROUND OF THE INVENTION

The unmanned mobile robot industry has seen tremendous growth in recent years. With the onset of the pandemic, contactless robotic deliveries became a necessity to safeguard the safety of communities. Wheeled mobile robots refer to unmanned ground vehicles that may, autonomously or semi-autonomously, travel in indoor and/or outdoor environments to perform civilian and commercial tasks in lieu of human personnel.

A robot that travels in the same urban environment as humans may face different challenges than if it were to navigate on the street among vehicles. Objects within such space, like humans or animals, may not move in a predictable manner and may react negatively to the presence of unconventional objects, such as a mobile robot.

Urban areas represent challenges for mobile robots as the dynamics and structures of cities were not designed with these solutions in mind. Furthermore, members of society are not accustomed to the presence of these mobile robots in public spaces, limiting the speed of adoption of this technology. Some companies offer to address this issue by designing the front of the robot as a facsimile of a human face. For example, Serve Robotics has designed its mobile robot for deliveries with a front analogous to that of human eyes. While this reduces the negative perception of robotic solutions, the public does not fully empathize with the mobile robot due to the lack of interactivity in the robot-human exchanges.

With this limitation in consideration, it is proposed to add system with a screen to the mobile robot capable of projecting animated messages and human-like expressions. As such, the mobile robot may interact with onlookers by delivering computer-generated imagery with the intention of producing a positive reaction. Thus, this innovation offers a solution to the lack of empathy that a wheeled robot may create in crowded urban environments and facilitate its introduction into society.

The main objective of this invention is to enhance the perception of wheeled mobile robots in human environments by using a system incorporated into the robot capable of delivering computer-generated imagery through its frontal screen. The method for this is done by creating animations as GIF files with a resolution of 32×64, which are then converted into code with an open-source web tool. These GIF files are incorporated into the mobile wheeled robot's screen interface as code to reproduce the animated images in the LED screen to bystanders.

The method by which this feature is activated from the mobile robot's interface is by input from a human supervisor. The human supervisor may choose to display a particular animated image on the mobile robot's front LED screen from a pre-assembled set and/or choose for the animations to rotate in no particular order as the robot navigates urban environments.

### SUMMARY OF THE INVENTION

A system and method for animating and displaying images via a mobile robot. The mobile robot includes a screen and a processor wherein the processor executes computer readable commands, thereby displaying animations onto the screen.

### BRIEF DESCRIPTION OF THE DRAWINGS

FIG. 1 is a diagram of the network of the present invention.

FIG. 2 is an additional diagram of the network of the present invention.

FIG. 3 is an additional diagram of the network of the present invention.

FIG. 4 is a process diagram of the present invention.

FIG. 5 is a component diagram of the mobile robot of the present invention.

FIG. 6 is a process diagram of the animation process of the present invention.

FIG. 7 is a diagram of one embodiment of the screen layout of the present invention.

FIG. 8 is a pictorial representation of the animation in memory of the present invention.

FIG. 9 is a pictorial representation of the color rendering system of the present invention.

FIG. 10 is a pictorial representation of the display buffer mapping system of the present invention.

FIG. 11 is a pictorial representation of the display buffer system of the present invention.

FIG. 12 is a diagram of the update function with drawing routine and timing assessment of the present invention.

FIG. 13 is a pictorial representation of two rows of pixels during the animation process of the present invention.

FIG. 14 is a front view of the housing of the mobile robot of the present invention.

FIG. 15 is an image of the first part of “you look good” message.

FIG. 16 is an image of the second part of “you look good” message.

FIG. 17 is an image of the wink face black.

FIG. 18 is an image of the first part of “Upps” message.

FIG. 19 is an image of the second part of “Upps” message.

FIG. 20 is an image of the first part of “Thank you” message.

FIG. 21 is an image of the second part of “Thank you” message.

FIG. 22 is an image of the first part of Star Face Black.

FIG. 23 is an image of the second part of Star Face Black.

FIG. 24 is an image of the first part of Sleep Face Black.

FIG. 25 is an image of the second part of Sleep Face Black.

FIG. 26 is an image of the first part of Serious Face Black.

FIG. 27 is an image of the second part of Serious Face Black.

FIG. 28 is an image of the First part of “See you later” message.

FIG. 29 is an image of the Second part of “See you later” message.

FIG. 30 is an image of the Sad Face Black.

FIG. 31 is an image of the First part of “Let me go” message.

FIG. 32 is an image of the Second part of “Let me go” message.

FIG. 33 is an image of the First part of Kiwi Face Black.

FIG. 34 is an image of the Second part of Kiwi Face Black.

FIG. 35 is an image of the First part of “I need help” message.

FIG. 36 is an image of the Second part of the “I need help” message.

FIG. 37 is an image of the “I can't be late” message.

FIG. 38 is an image of the “Hello” message.

FIG. 39 is an image of the Heart Face Black.

FIG. 40 is an image of the “Have a nice day” message.

FIG. 41 is an image of the Happy Face Black.

FIG. 42 is an image of the First part of the “Enjoy your meal” message.

FIG. 43 is an image of the Second part of the “Enjoy your meal” message.

FIG. 44 is an image of the Crying Face Black.

FIG. 45 is an image of the Confident Face Black.

FIG. 46 is an image of the Concern Face Black.

FIG. 47 is an image of the Angry Face Black.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification, and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate.

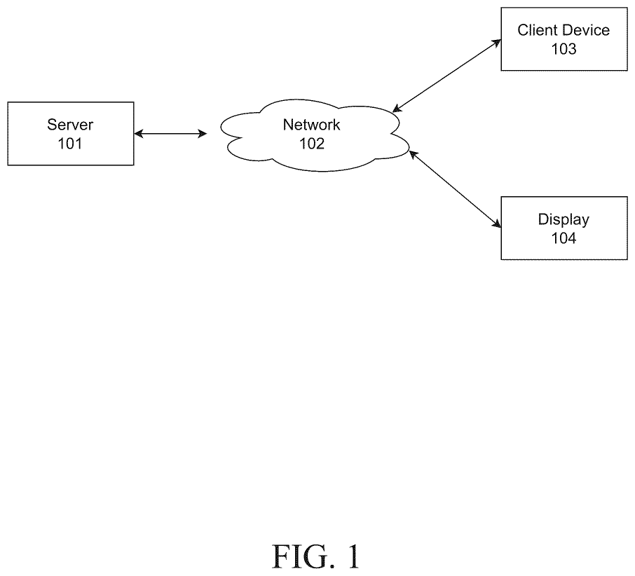

The present disclosure includes many aspects and features. Moreover, while many aspects and features relate to, and are described in the context of a method of displaying animated images via a mobile robot, embodiments of the present disclosure are not limited to use only in this context. As shown and described in FIGS. 1-47, the present invention is a method of displaying animated images via a mobile robot. Furthermore, the present invention comprises a computer apparatus and a non-transitory computer-readable storage medium.

As shown in FIG. 1, the reference invention comprises a server 101, a network 102, a client device 103, and a display 104. In the context of the present invention, the client device 103 is a user device capable of communicating with the network 102. Furthermore, within the context of the present invention, the display 104 is an LED screen embedded within a mobile robot, wherein said LED screen is outwardly visible to a third party.

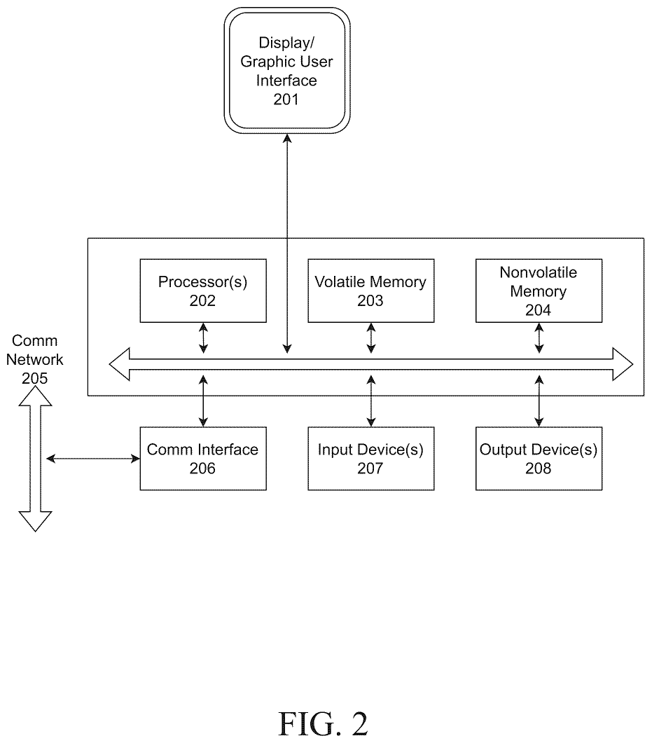

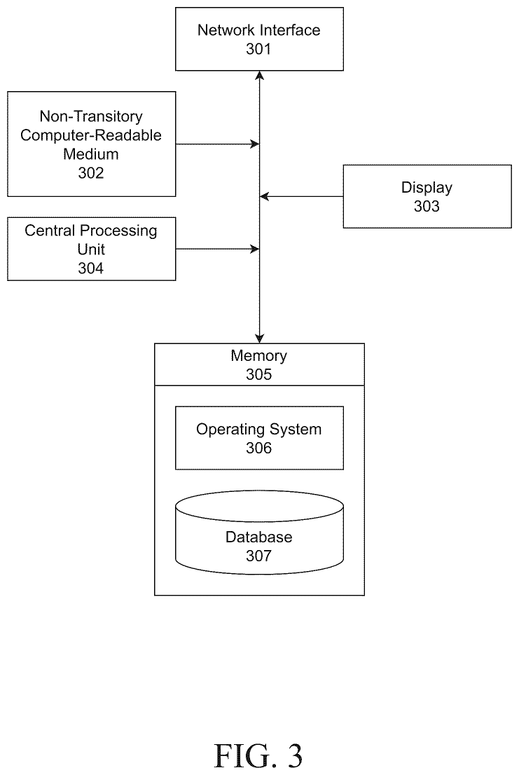

Referencing FIG. 2 and FIG. 3, the present invention further comprises a computer apparatus comprising a graphic user interface 201, an at least one processor 202, a volatile memory 203, a non-volatile memory 204, a communication network 205, a communication interface 206, an at least one input device 207, and an at least one output device 208. In the context of the present invention, the Graphic User Interface (GUI) 201 is a visual interface that allows users to interact with electronic devices through graphical icons and visual indicators. In the context of the present invention, the GUI 201 facilitates the interaction between the user and the present invention and executed applications by using windows, icons, buttons, and menus. Furthermore, the processor 202 interprets and executes instructions from the system hardware and software, thus carrying out operations such as arithmetic, logic, control, and input/output (I/O) operations specified by the instructions in the program. Moreover, the volatile memory 203, including random access memory (RAM) a type of memory that requires power to maintain the stored information. On the other hand, the non-volatile memory 204, within the context of the present invention comprises Read-Only Memory (ROM), Solid-State Drives (SSD), and hard drives, whereby said memory can retain stored information when not powered. In the context of the present invention, the nonvolatile memory 204 is used for the long-term storage of data and programs. The communication network 205 in the context of the present invention and system refers to the infrastructure that allows for the transmission of data between computers and other devices. The communication interface 206 is a hardware and software component that enables the present invention to communicate with other devices or networks including the user and client devices. Additionally, within the context of the present invention, the input device 207 is a hardware component that allows the user to enter data and control signals into the system. Input devices may comprise keyboards, mice, touchscreens, scanners, microphones, and related devices.

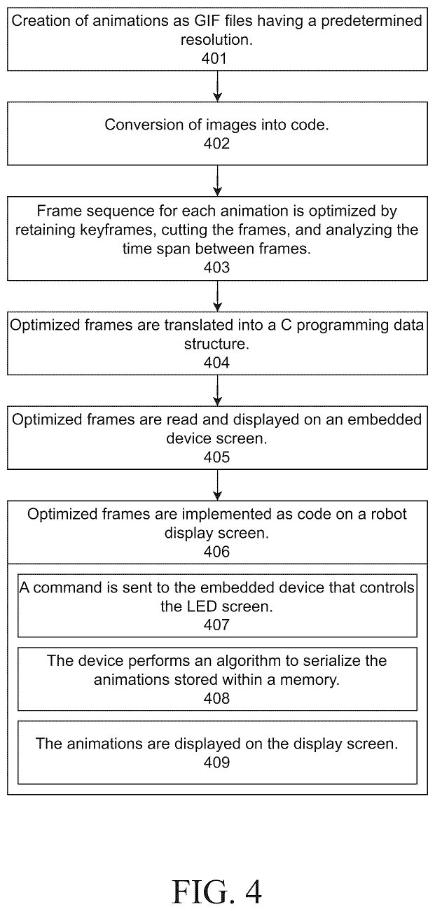

In reference to FIG. 4, the present invention comprises a method comprising the steps: creating 401 animations in the form of GIF files having a predetermined resolution; converting 402 image from the GIF file into computer readable code; optimizing 403 a frame sequence for each animation by retaining keyframes, cutting each frame, and analyzing a time span between the frames; translating 404 the optimized frames into a C programming data structure; reading 405 and displaying the optimized frames via an embedded device screen; and implementing 409 optimized frames as code onto a mobile robot display screen. Furthermore, the present invention further comprises sending 407 a command to an embedded device that controls an LED screen. Further, the present invention may further include performing 408 an algorithm to serialize the animations stored within a memory.

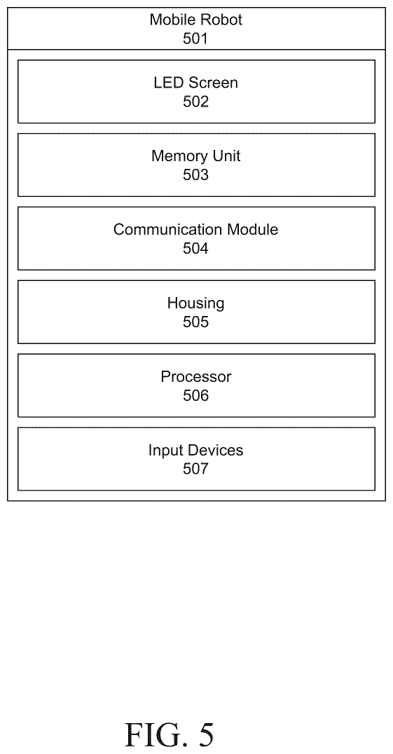

As shown in FIG. 5, in some embodiments of the present invention, the mobile robot 501 comprises hardware components allowing the method of the present invention to be executed including an LED screen 502, a memory unit 503, a communication module 504, a processor 506, and an at least one input device 507. Furthermore, the present invention comprises a housing 505 wherein the housing 505 is a fiberglass container wherein the memory unit 503, communication module 504, processor 506, and at least one input device 507 are contained within. Additionally, the LED screen 502 is embedded within an outwardly surface of the housing 505, thus visibly accessible via a third-party user.

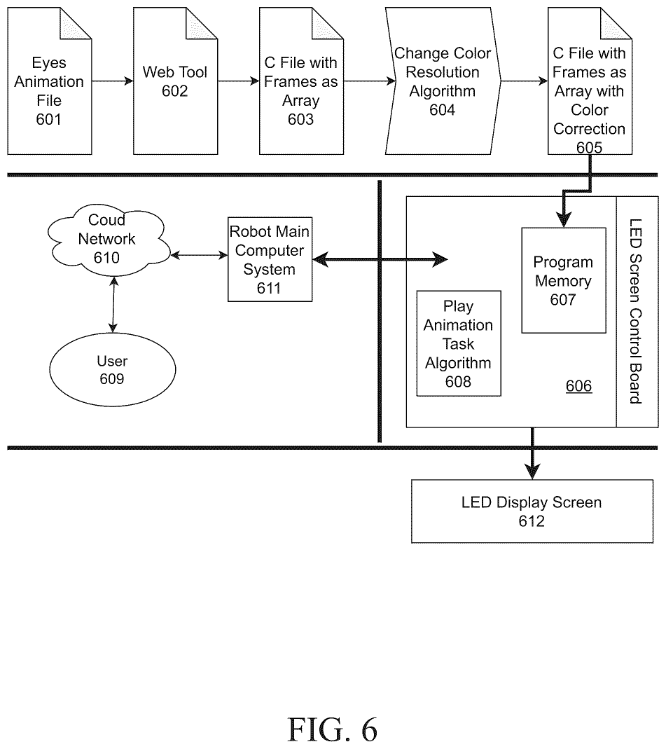

As shown in FIG. 6, the computer apparatus and non-transitory computer-readable storage medium, within the context of the present invention, configure the apparatus to undergo an animation pre-process comprising an eye animation file process 601, a web tool process 602, a C file with frames as array process 603, a color correction process 604, and a color corrected C file process 605. During the eyes animation file process 601, the animation is designed, taking into account a predetermined set of guidelines set for the present invention, producing a GIF file. In the context of the preferred embodiment of the present invention a GIF file is utilized, although is not limited to such and the present invention may utilize similar media files. The web tool process 602 comprises using a web tool to produce pixelated art. In the preferred embodiment of the present invention, the pixelated art is selected from either a still image or a series of still images in succession, thus generating an moving animation. Once the pixelated images are produced, the images and animations are given a predetermined size and frame rate. The images are then manipulated within the application to be resized, enabling the GIF video to match a predetermined size. In the preferred embodiment of the present invention, the size is 32×64 pixels. The web tool is then used to output a C file containing the animation frames in the form of an array. The C file is then processed by an algorithm that changes the color resolution, potentially to match the capabilities of the LED screen it is intended for. In the preferred embodiment of the present invention, the web tool creates, in the previous step, a file using the RGBA color space, with a resolution of 32 bits. The LSB is Red, and the MSB is A (alpha). In some embodiments of the present invention, the required pixel color resolution used in the MCU algorithm is a 16-bits word, not containing Alpha information, with 5 bits for Red color, 6 bits for Green and 5 bits for Blue. Pixel color can also be represented as RRRRRGGGGGGBBBBB, where each letter represents one bit for each color group. Within the algorithm, variables are declared to store individual color components including RGBA and a final converted color. Then, loops through each pixel extracts individual color components (alpha, red, green, blue) from the 32-bit pixel value using bitwise masking and shifting; converts each color component to a floating-point value and scales said components by the alpha value; quantizes the scaled color values back to integer values and combines said values into a 16-bit color format; writes the converted 16-bit color value in hexadecimal format and generates the output file. After the color correction process 604, color corrected C files with the frames as an array are applied and transmitted to a memory.

As further shown in FIG. 6, the present invention further comprises an LED screen control board 606. In the context of the present invention, The LED screen board 606 is a custom PCB that utilizes a microcontroller (MCU) with CANFD capabilities. The LED screen control board communicates with the main computer systems of the present invention to receive supervisor commands about which eyes or messages to display, depending on the specific operational needs of the robot or its interaction with third party users. Additionally, the LED screen board 606 manages the interface with the physical LCD screen, loading each animation for display. The C file generated is included in the MCU Firmware. As a result, the pixel data for each animation frame is stored in the MCU's internal memory 607, ready to be displayed. In the preferred embodiment of the present invention, the LED screen control board 606 comprises a program memory 607 and a play animation task algorithm 608. In the context of the present invention, the algorithm 608 is a computer executable algorithm that controls the animation. In the preferred embodiment of the present invention, the algorithm 607 is a task in a real-time operating system, running in an infinite loop and using RTOS primitives to manage timing and resource access. Additionally, the algorithm 607 may act as a consumer in a producer-consumer scenario wherein a part of the system (the producer) sets up animations to be displayed, and the algorithm function (the consumer) displays the animations. Moreover, the algorithm further comprises a double buffering function wherein said algorithm draws the next frame of the animation to an off-screen buffer, then updates the display. Furthermore, the algorithm 607 function uses a mutex to ensure exclusive access to the screen when it's updating the display, avoiding race conditions.

In the preferred embodiment of the present invention, the algorithm 607 comprises a mutex locking for screen access function wherein the task acquires exclusive access to the led screen, which ensures that no other task can write to the screen simultaneously, preventing display conflicts. Furthermore, within the preferred embodiment of the present invention, the algorithm 607 further comprises an initial delay for animation transition function wherein the task waits for a brief period before starting the animation. This delay ensures a smooth transition between animations or frames. Further, the algorithm 607 comprises an animation frame selection and looping function wherein the function checks if there is an animation to play. If there's an active animation, the function selects the current frame to display based on an index. Once the last frame is displayed, the algorithm wraps around to the first frame, enabling the animation to loop. The algorithm 607 also comprises a frame positioning and background filling function wherein the task decides whether to display it as a full-frame (covering the entire screen) or in a specified position. The background is then filled with a specific color to prepare for the frame display. The algorithm further comprises a frame drawing task wherein said task draws the frame on the screen and supports both monochrome and RGB frames. For RGB frames, the algorithm 607 can handle additional features such as splitting the frame into parts, drawing each part separately, and mirroring certain parts if required. Within a frame display and rate control function, the task configures the system to update, thus showing a new frame. The frame display and rate control task then wait for a period before displaying the next frame. The wait time is determined on the frame's desired display period, ensuring that the animation plays back at the correct speed. If the animation is flagged to change, the task resets the frame index to start from the beginning. In an alternative task, a fallback for no animation function determines if there is not an animation to display, and proceeds to fill the screen with a default background color and waits for a brief period before checking again. The function ensures that the screen does not remain frozen on the last frame of the previous animation. Lastly, a mutex unlocking task releases the mutex once the frame is displayed, or the fallback color is set, allowing other tasks to access the screen.

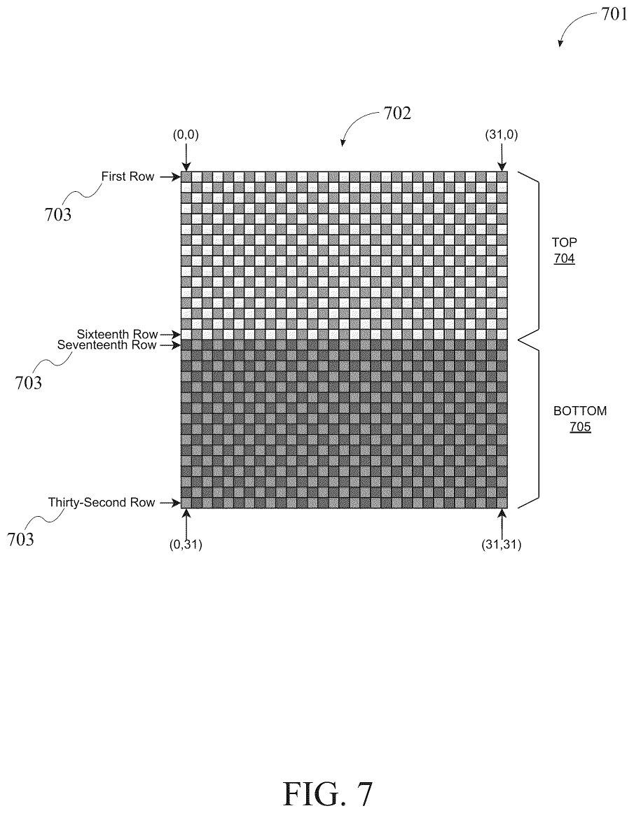

As shown in FIG. 7, in the preferred embodiment of the present invention, the LED screen comprises a screen layout wherein said layout comprises a top section 704, a bottom section 705, and a plurality of rows of pixels 703. Each row of pixels comprises a plurality of pixels 702. In the preferred embodiment of the present invention, the plurality of rows of pixels 703 comprises a plurality of rows composing the top section 704, and a plurality of rows composing the bottom section 705. In the preferred embodiment, when a row is selected, color data from two pixels load onto the screen.

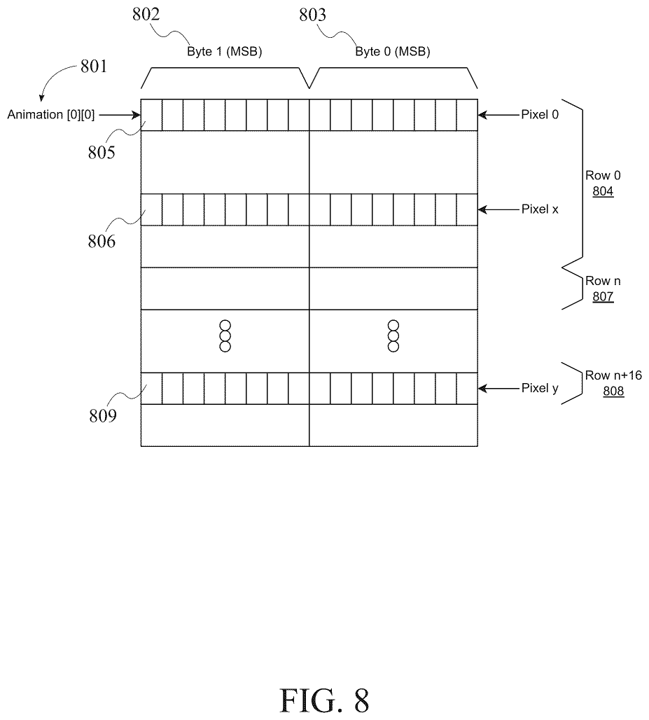

As shown in FIG. 8, the present invention further comprises an animation 801 in memory system wherein images and animations are stored in memory as a plurality of arrays 802, 803 of 16-bit words containing the RGB color information of every pixel in every frame 805, 806, 809.

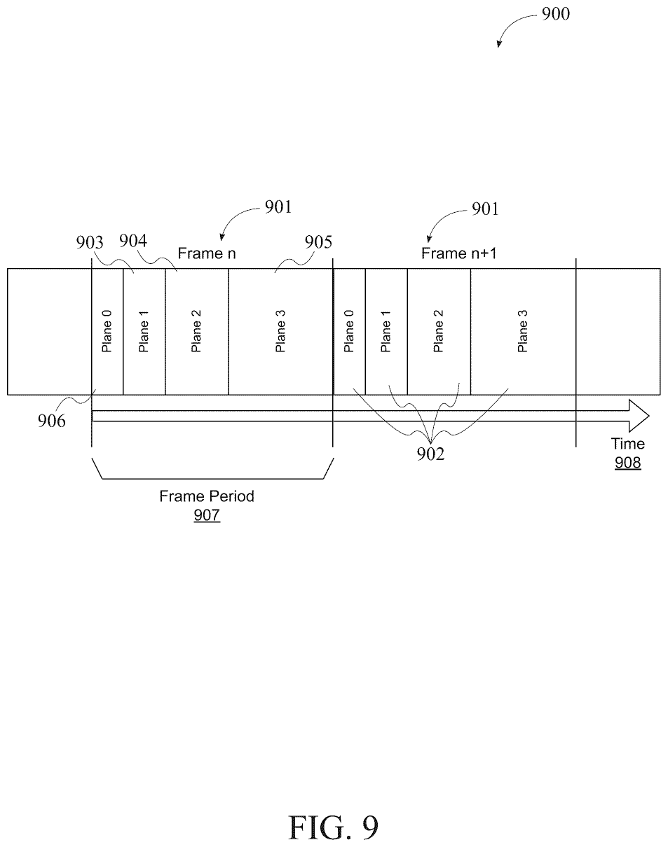

As shown in FIG. 9, the color rendering system divided every image and frame into a plurality of unique color plane 901 and the screen control board displays each plane with a variable time duration 908. In the context of the present invention, the plurality of planes comprises a first plane 906, a second plane 903, a third plane 904, and a fourth plane 905. The summation of consecutive planes composes a frame period 907 wherein said frame period comprises a duration of time 908. By displaying four planes per frame in a rapid succession, a color resolution is obtained based on the Persistence Of Vision effect.

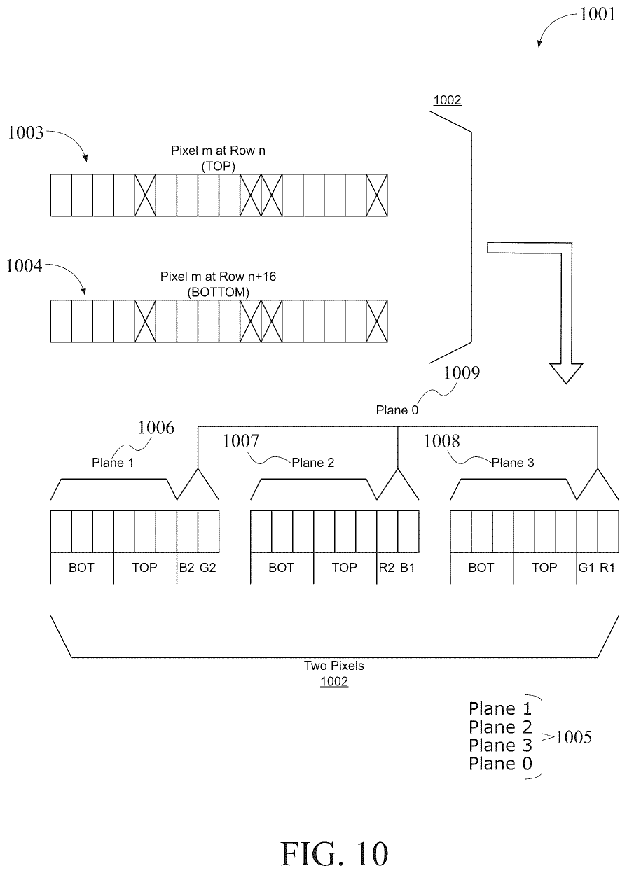

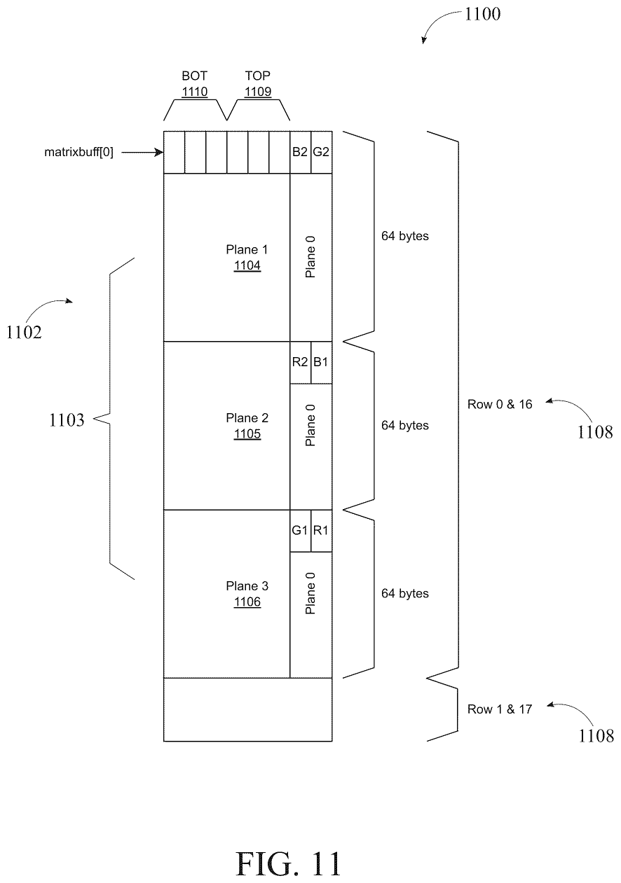

As shown in FIG. 10 and FIG. 11 the present invention comprises a display buffer mapping function wherein the pixels are organized in a manner that is accessible for querying. In the preferred embodiment, the organization format combines information from two pixels into three bytes.

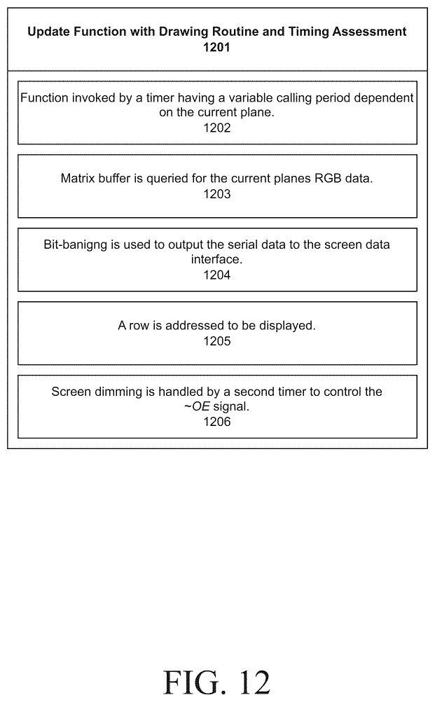

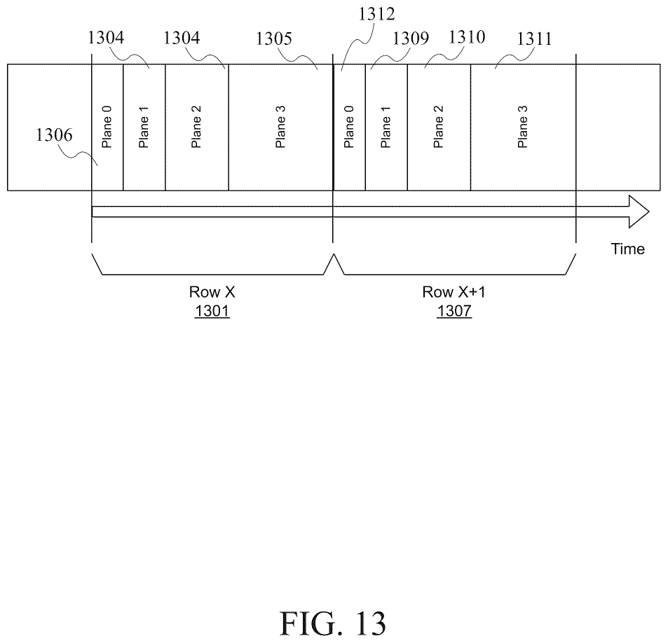

Furthermore, as shown in FIG. 12 and FIG. 13, the present invention comprises an update function with a drawing routine and a timing assessment 1201. In the preferred embodiment of the present invention, the update function 1201 comprises a method comprising the steps: invoking 1202, by a first timer, a variable calling period dependent on a plane specification; querying 1203 the plurality of planes for color data; outputting 1204 serial data onto a screen data interface; addressing 1205 rows to be displayed; and dimming 1206 the screen via a second timer. Additionally, the present invention comprises a method comprising the steps: addressing row X 1301; reading pixel information from plane 0 1306 of row X 1301 from the matrix buffer; reading pixel information from plane 1 1304 of row X 1301 from the matrix buffer having a duration that is twice that of plane 0 1306; reading pixel information from plane 2 1304 of row X 1301 from the matrix buffer having a duration that is twice that of plane 1 1303; reading pixel information from plane 3 1305 of row X 1301 from the matrix buffer having a duration that is twice that of plane 2 1304; and repeating the process for row X+1 1307.

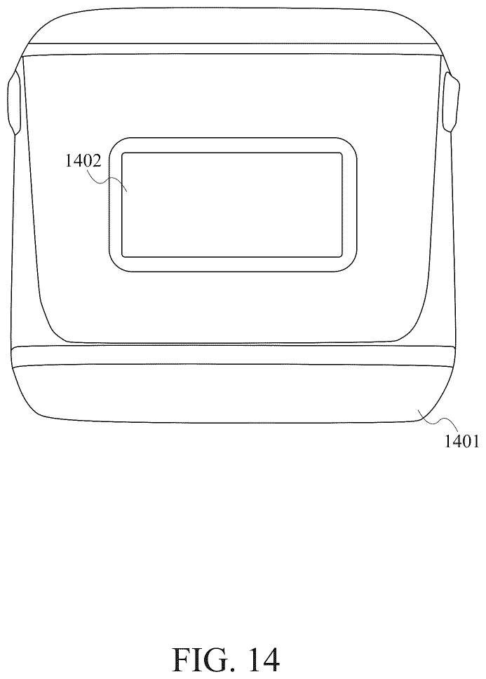

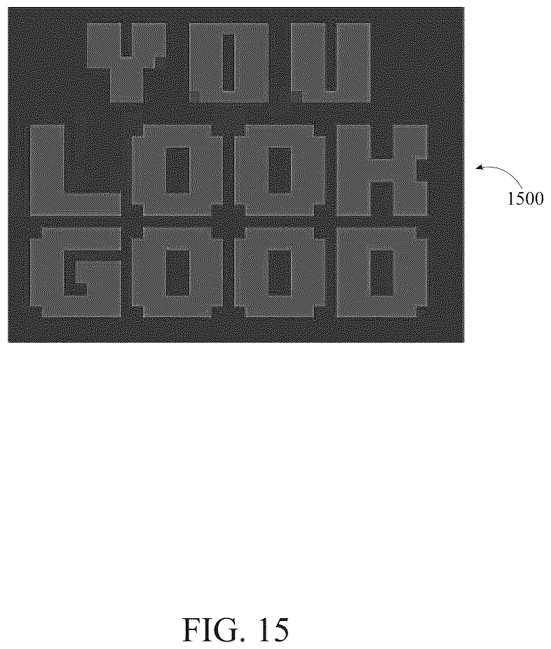

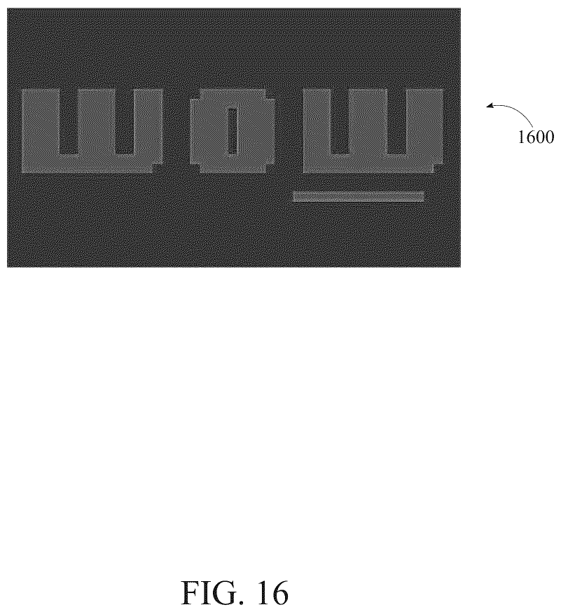

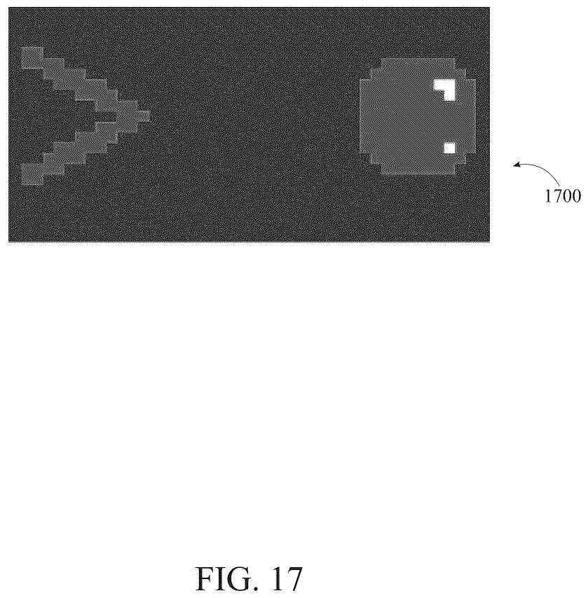

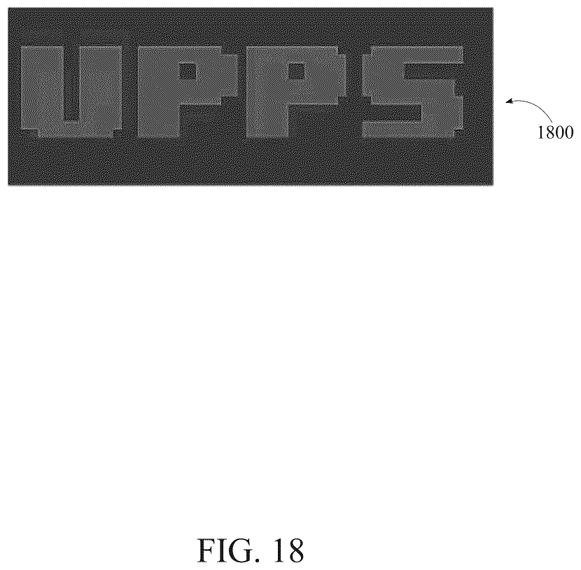

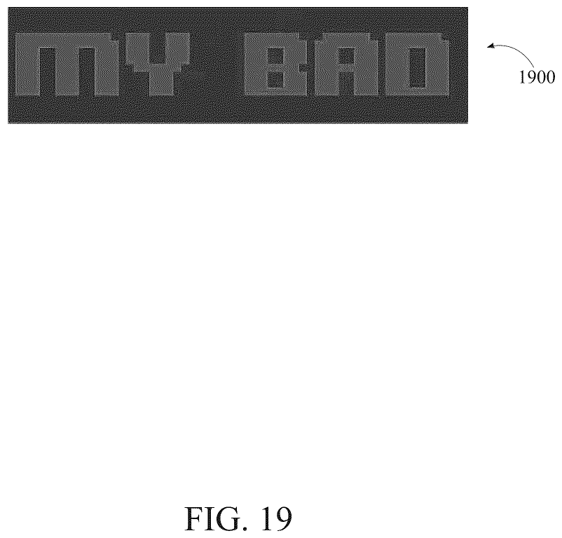

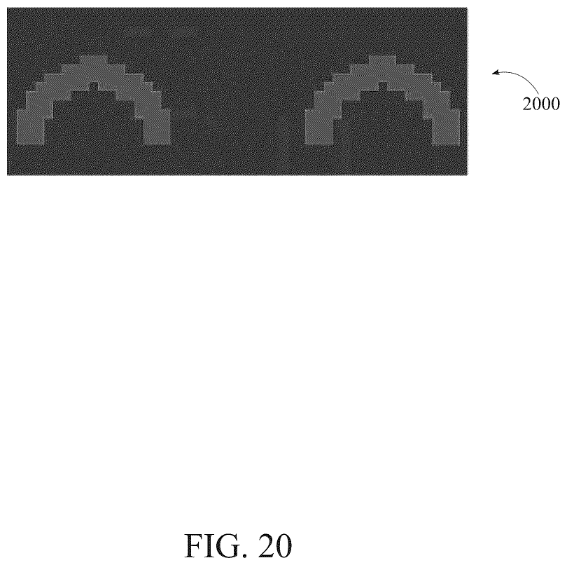

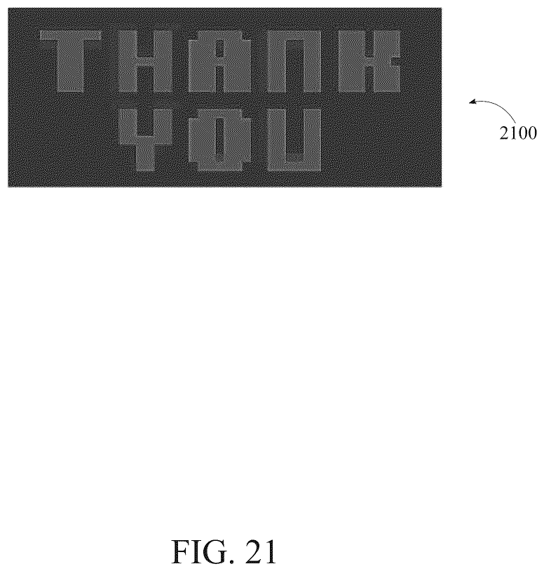

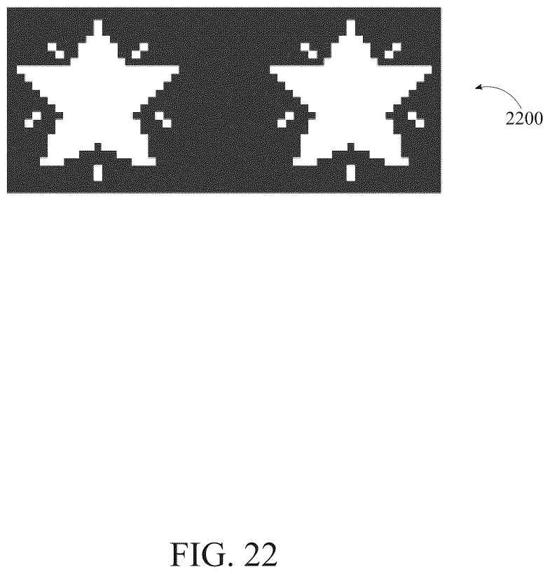

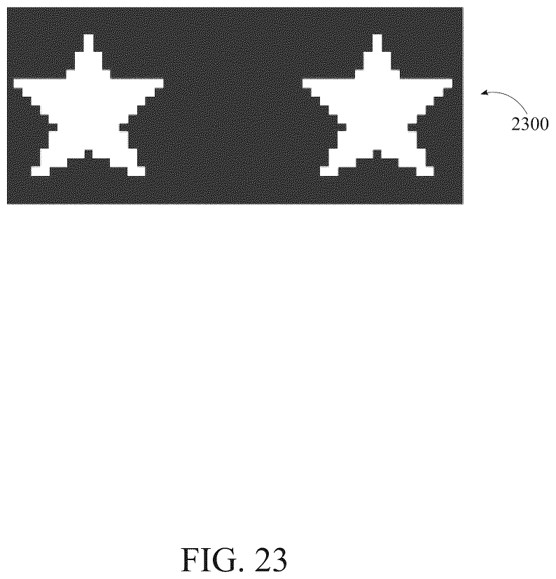

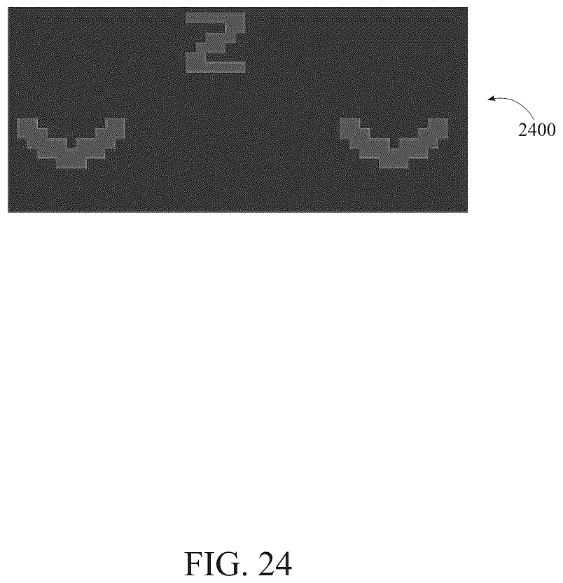

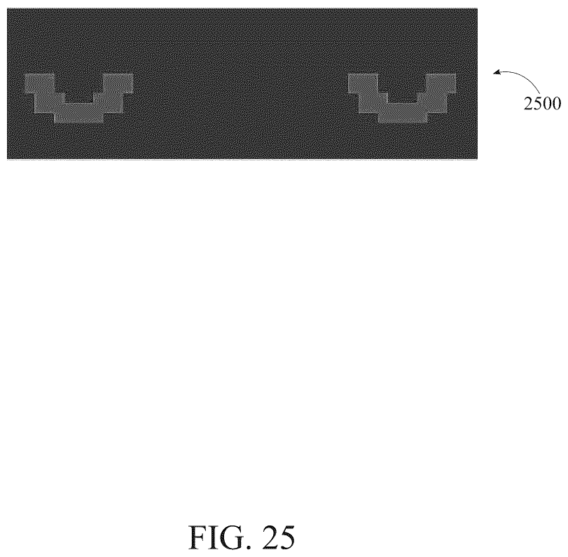

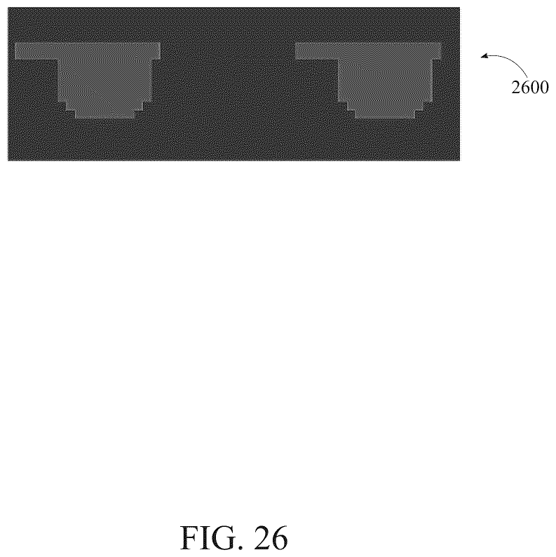

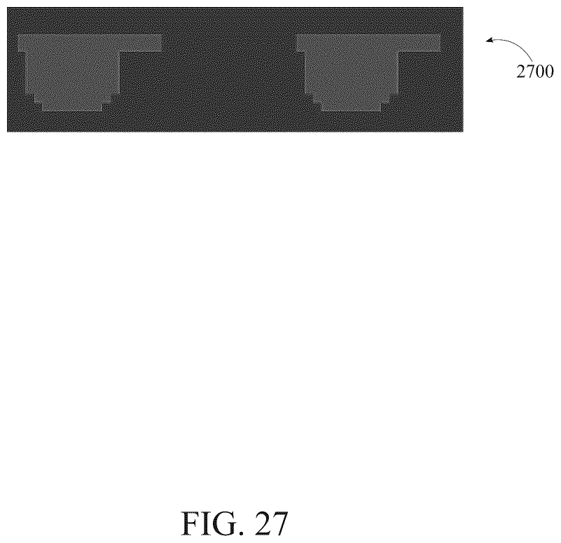

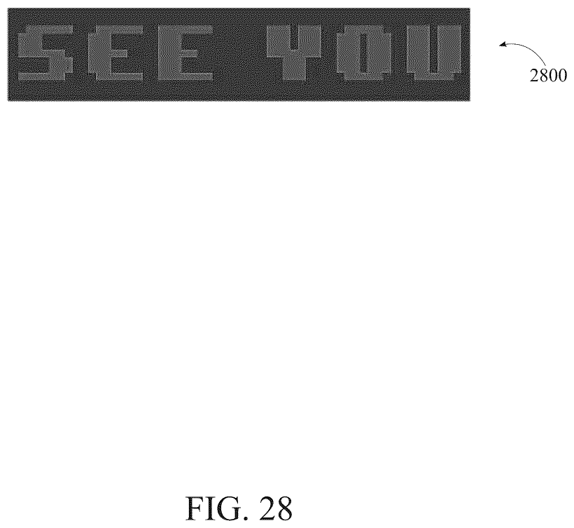

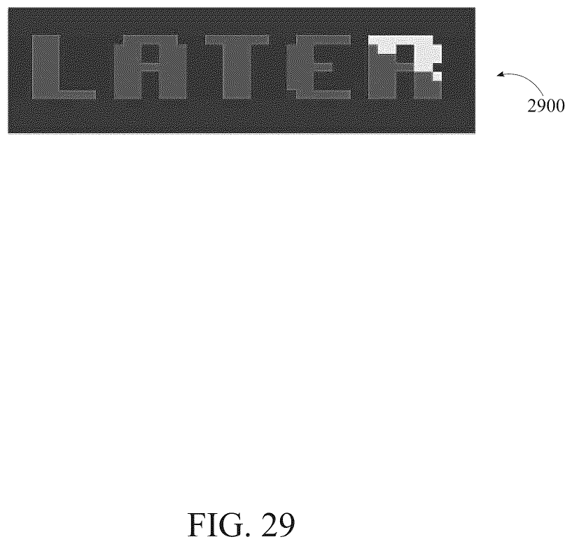

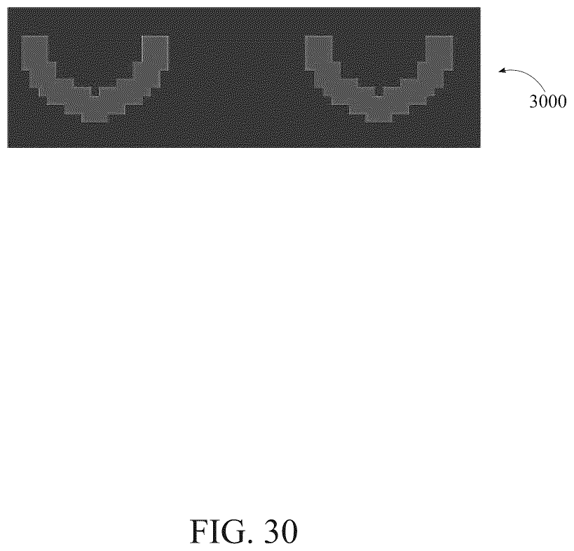

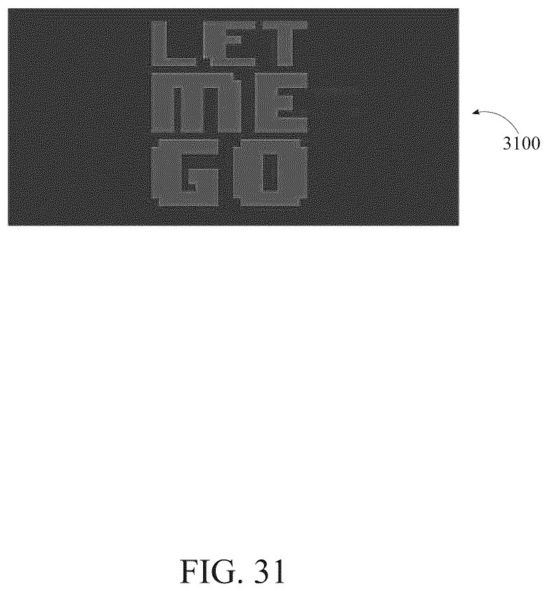

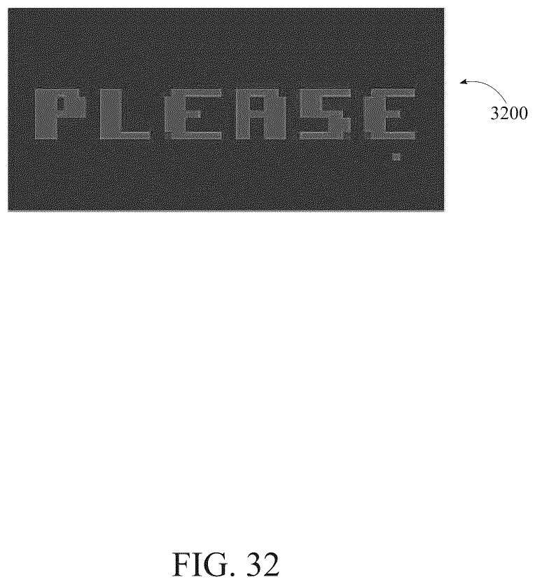

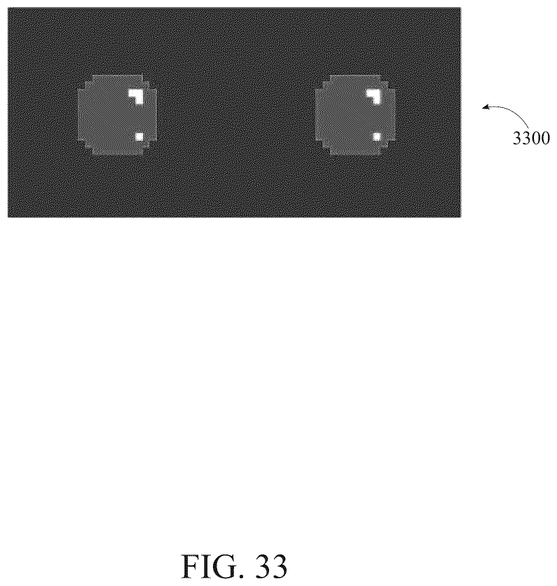

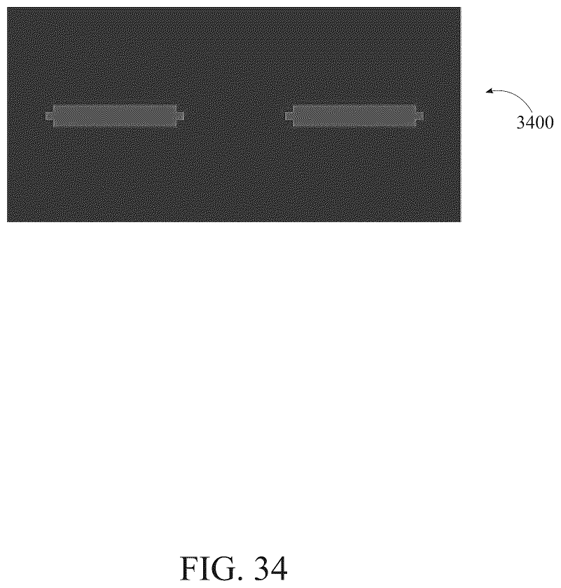

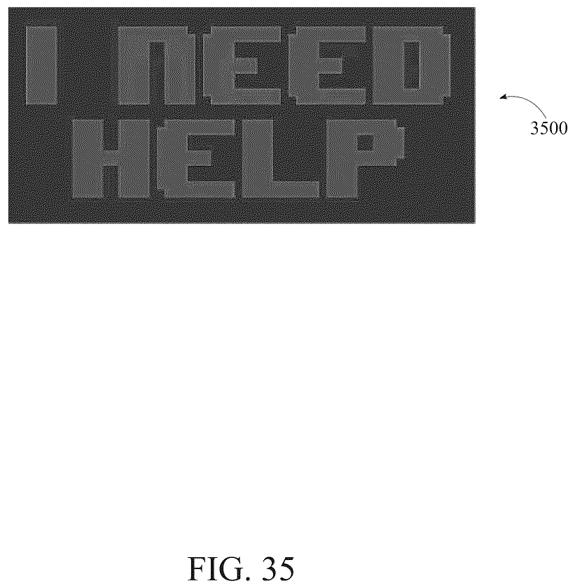

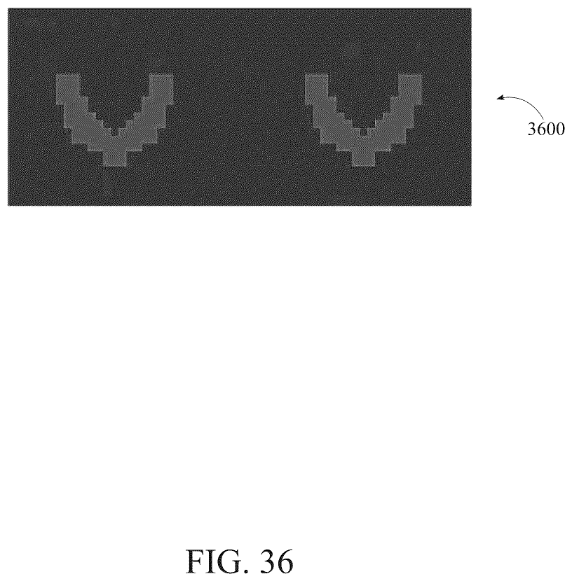

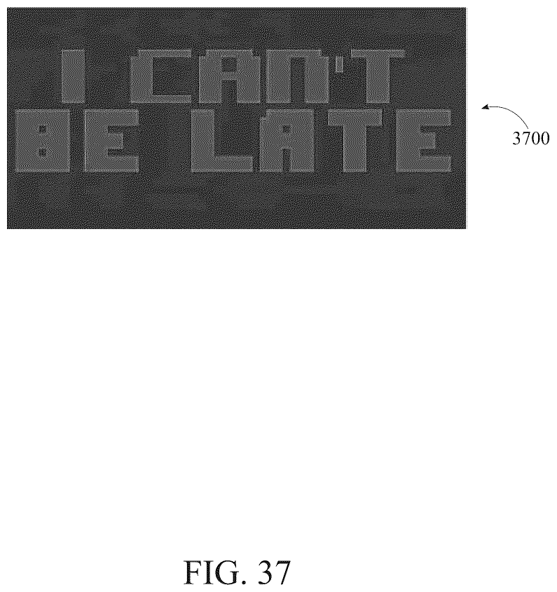

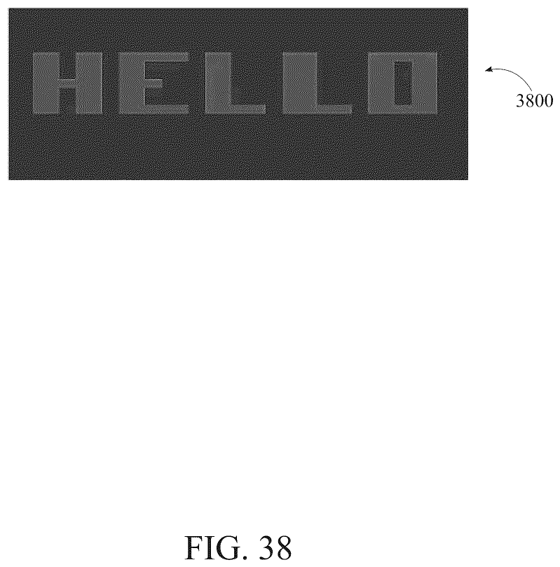

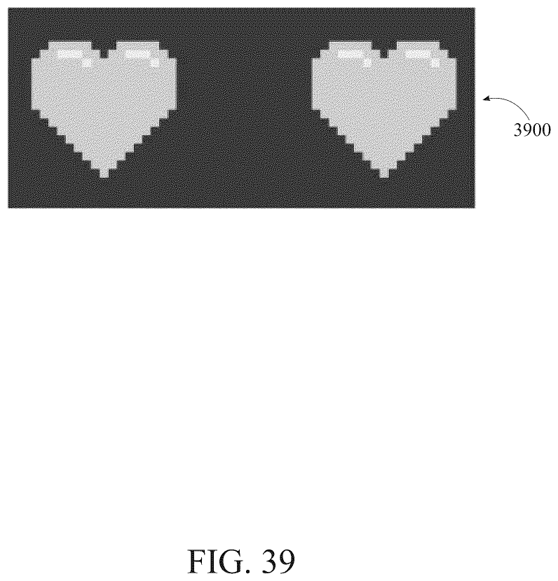

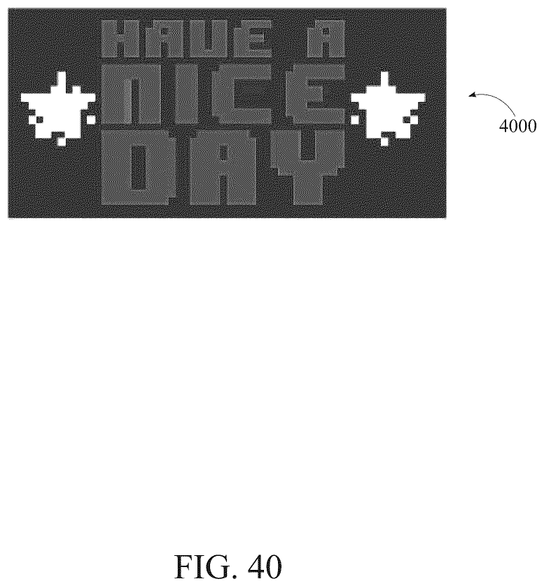

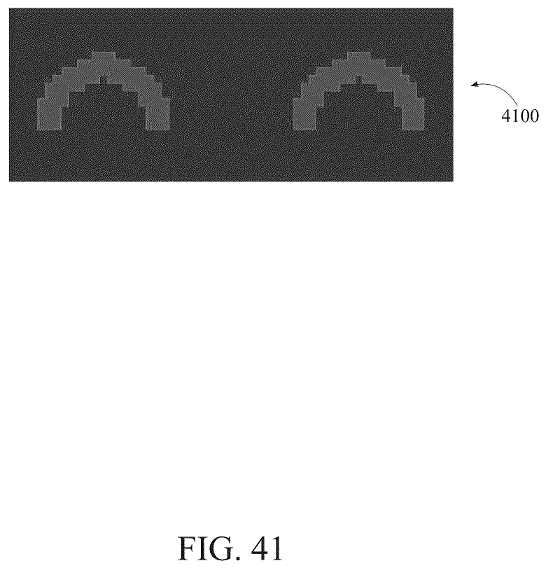

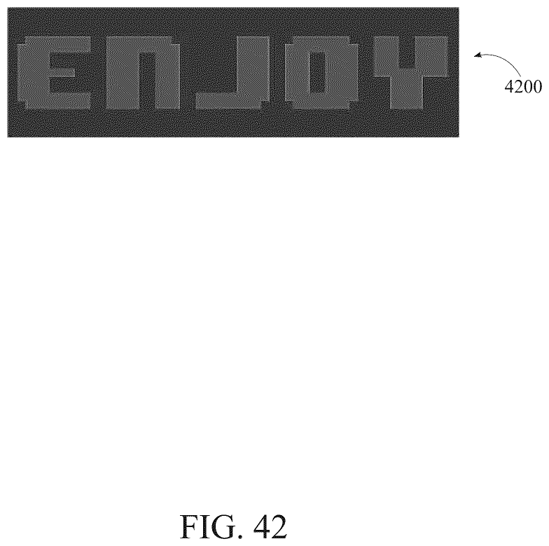

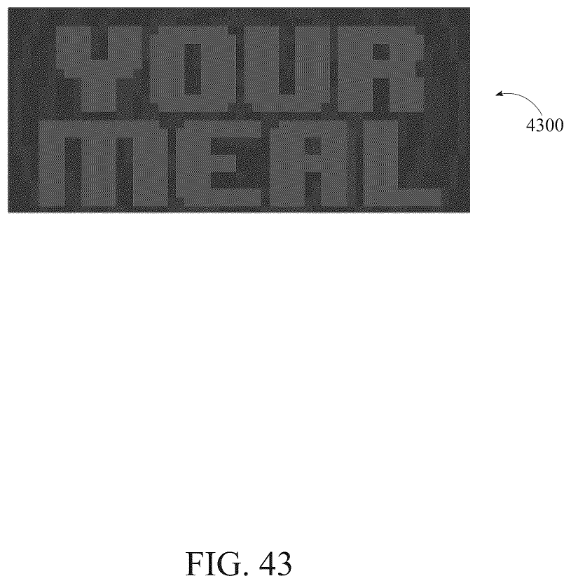

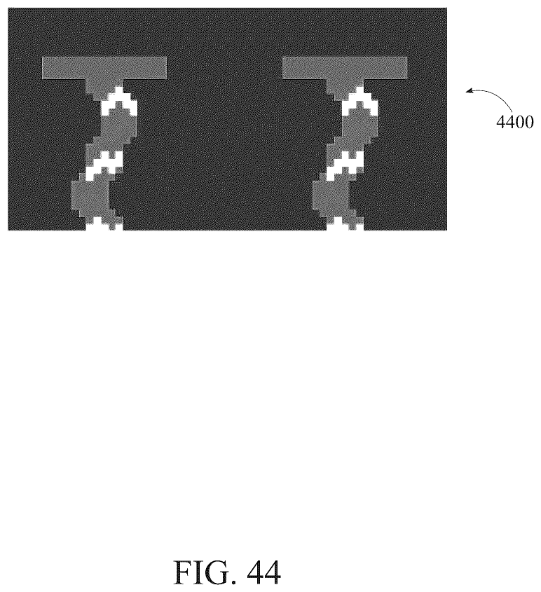

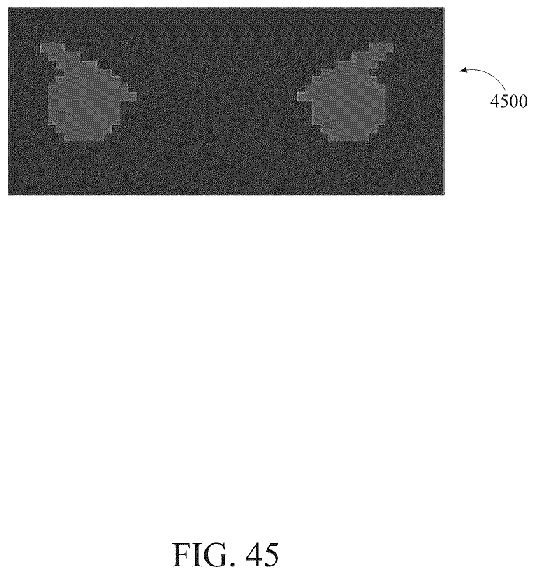

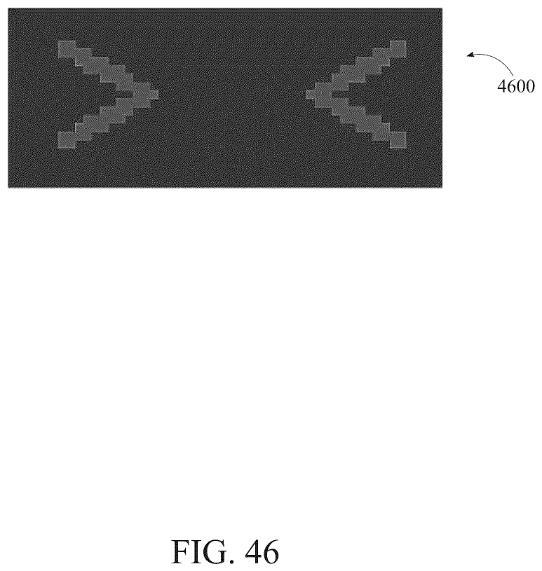

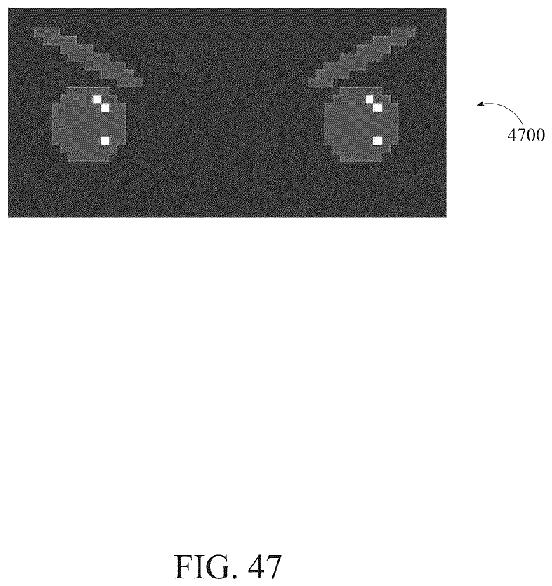

In the preferred embodiment of the present invention, referring to FIG. 14, the LED screen 1402 is embedded in the housing 1401. The LED screen 1402 then displays pixelated images as shown in FIG. 15 through FIG. 47. In some embodiments of the present invention, as shown in FIG. 15, FIG. 16, FIG. 18, FIG. 19, FIG. 21, FIG. 28, FIG. 29, FIG. 31, FIG. 32, FIG. 35, FIG. 37, FIG. 38, FIG. 42, and FIG. 43, the images on the LED screen depict textual characters. Alternatively, in figures such as FIG. 17, FIG. 20, FIG. 22, FIG. 23, FIG. 24, FIG. 25, FIG. 26, FIG. 27, FIG. 30, FIG. 33, FIG. 34, FIG. 36, FIG. 39, FIG. 41, FIG. 44, FIG. 45, FIG. 46, FIG. 47, the LED screen displays pixelated graphic images resembling shapes, eyes, and similar graphic images. In some embodiments of the present invention, such as FIG. 40, the LED screen displays a combination of textual characters and shapes.

Although the invention has been explained in relation to its preferred embodiment, it is to be understood that many other possible modifications and variations can be made without departing from the spirit and scope of the invention.

1. A method comprising:
creating animations in the form of GIF files having a predetermined resolution;
converting image from the GIF file into computer readable code;
optimizing a frame sequence for each animation by retaining keyframes, cutting each frame, and analyzing a time span between the frames;
translating the optimized frames into a C programming data structure;
reading and displaying the optimized frames via an embedded device screen; and
implementing optimized frames as code onto a mobile robot display screen.

2. The method as claimed in claim 1 wherein:
during the implementation of the optimized frames as code onto a mobile robot display screen, a computer executable code is sent to the embedded device that controls an LED screen.

3. The method as claimed in claim 2 further comprising:
serializing the animations within a stored memory.

4. The method as claimed in claim 3 further comprising:
displaying the animations of the display screen.

5. The method as claimed in claim 4 wherein the mobile robot comprises:
the LED screen;
the stored memory unit;
a communication module;
a housing;
a processor; and
at least one input device;
wherein:
the stored memory unit, the communication module, the processor, and the at least one input device are contained within the housing;
the housing being a fiberglass body acting as an external shield for the components of the mobile robot; and
the LED screen being embedded within the housing whereby the LED screen is outwardly visible.

6. The method as claimed in claim 5 further comprising:
a GIF animation file is designed in accordance with a predetermined set of guidelines;
processing the GIF file using a web tool whereby the animation file is converted into a pixelated image;
outputting the pixelated image as a C file containing frames in the form of an array;
processing the C file to change color resolution to align with capabilities of the LED screen; and
outputting the frames as a color corrected C file.

7. The method as claimed in claim 6 further comprising:
a user system;
a cloud network; and
a robot main computer system;
wherein:
the user system communicates information between the cloud network; and
the robot main computer system communicates information between the cloud network.

8. The method as claimed in claim 7 further comprising an LED screen control board utilizing a microcontroller and an internal memory whereby a computer executable command is stored, processed, and executed;
the robot main computer system communicates with the LED screen control board; and
the color corrected C files are delivered and stored within the internal memory of the LED screen control board.

9. The method as claimed in claim 8 wherein the C files are transmitted and displayed on the LED screen.

10. The method as claimed in claim 9 wherein the LED screen comprises:
a top section;
a bottom section; and
a plurality of rows of pixels;
wherein:
each of the rows of pixels comprises a plurality of pixels;
the plurality of rows comprising the top section compose an upper portion of the LED screen;
the plurality of rows comprising the bottom section compose a lower portion of the LED screen; and
each of the frames are divided into a plurality of planes.

11. The method as claimed in claim 10 wherein the animations displayed on the LED screen comprise graphic images.

12. The method as claimed in claim 10 wherein the animations displayed on the LED screen comprise text characters.

13. The method as claimed in claim 10 further comprising:
invoking, by a first timer, a variable calling period dependent on a plane specification;
querying the plurality of planes for color data;
outputting serial data onto a screen data interface;
addressing rows to be displayed; and
dimming the screen via a second timer.

14. A computing apparatus comprising:
a processor and a memory housed within a mobile robot;
the memory storing instructions that, when executed by the processor, configure the apparatus to:
create animations in the form of GIF files having a predetermined resolution;
convert image from the GIF file into computer readable code;
optimize a frame sequence for each animation by retaining keyframes, cutting each frame, and analyzing a time span between the frames;
translate the optimized frames into a C programming data structure;
read and display the optimized frames via an embedded device screen; and
implement optimized frames as code onto a mobile robot display screen.

15. The computer apparatus as claimed in claim 13 further comprising configuring the apparatus to:
send a computer executable code to the embedded device that controls an LED screen;
serialize the animations within a stored memory; and
display the animations of the display screen.

16. The computer apparatus as claimed in claim 14 further comprising configuring the apparatus to:
design a GIF file in accordance with a predetermined set of guidelines;
process the GIF file using a web tool whereby the animation file is converted into a pixelated image;
output the pixelated image as a C file containing frames in the form of an array;
process the C file to change color resolution to align with capabilities of the LED screen; and
output the frames as a color corrected C file.

17. The computer apparatus of claim 16 further comprising:
a user system;
a cloud network; and
a robot main computer system;
wherein:
the user system communicates information between the cloud network; and
the robot main computer system communicates information between the cloud network.

18. The method as claimed in claim 7 further comprising an LED screen control board utilizing a microcontroller and an internal memory whereby a computer executable command is stored, processed, and executed;
the robot main computer system communicates with the LED screen control board; and
the color corrected C files are delivered and stored within the internal memory of the LED screen control board.

19. A non-transitory computer readable storage medium comprising:
a processor and a memory housed within a mobile robot;
the memory storing instructions that, when executed by the processor, configure the apparatus to:
create animations in the form of GIF files having a predetermined resolution;
convert image from the GIF file into computer readable code;
optimize a frame sequence for each animation by retaining keyframes, cutting each frame, and analyzing a time span between the frames;
translate the optimized frames into a C programming data structure;
read and display the optimized frames via an embedded device screen; and
implement optimized frames as code onto a mobile robot display screen.

20. The non-transitory computer-readable storage medium of claim 19 further comprising the steps of:
designing a GIF file in accordance with a predetermined set of guidelines;
processing the GIF file using a web tool whereby the animation file is converted into a pixelated image;
outputting the pixelated image as a C file containing frames in the form of an array;
processing the C file to change color resolution to align with capabilities of the LED screen; and
outputting the frames as a color corrected C file.
